(19) United States
(12) Patent Application Publication
(10) Pub. No.: US 2007/0105534 A1
(43) Pub. Date: May 10, 2007

(54) SYSTEM AND METHOD FOR TAKING OVER INCOMING CALL

(75) Inventor: Ching-Yu Lin, Hsinchu City (TW)

Correspondence Address: SNELL & WILMER L.L.P. (Main), 400 EAST VAN BUREN, ONE ARIZONA CENTER, PHOENIX, AZ, 85004-2202, US

(73) Assignee: BENQ CORPORATION, Taoyuan (TW)

(21) Appl. No.: 11/550,290

(22) Filed: Oct. 17, 2006

(30) Foreign Application Priority Data
Nov. 9, 2005 (TW) 094139239

(51) Int. Cl. H04M 11/10

(52) U.S. Cl. 455/413; 455/426.1

(57) ABSTRACT

A system and a method for managing an incoming call are provided. The system includes a first mobile device wirelessly connected to a first answering module and a second mobile device wirelessly connected to a second answering module. The first mobile device and the second mobile device communicate with a telephone system. An authentication matrix for grouping the first and second answering modules into a same group is stored in both the first and the second answering modules. When the first mobile device receives an incoming call through the telephone system, the second answering module selectively takes over to communicate with the incoming call.

### CROSS REFERENCE TO RELATED APPLICATIONS

This application claims the right of priority based on Taiwan Patent Application No. 094139239 entitled “System And Method For Taking Over Incoming Call In Mobile Device,” filed on Nov. 09, 2005, which is incorporated herein by reference and assigned to the assignee herein.

### FIELD OF INVENTION

The present invention generally relates to a system and a method for managing an incoming call, and more particularly, to a system and a method for managing an incoming call to be answered by other wireless receivers.

### BACKGROUND OF THE INVENTION

Mobile phones equipped with wireless answering earphones are quite popular recently. Such wireless answering earphones include Inferred answering modules and Bluetooth answering modules, and the Bluetooth answering modules are much more prevailing. Using Bluetooth technology in audio frequency signal transmission not only provides longer transmission distance and better transmission angles, but also reduces power consumption. Hence, research related to Bluetooth answering module has been widely developed. For example, Taiwan Patent Application No. 92100448 discloses a method for connecting a Bluetooth answering module to multiple electronic devices. The matched Bluetooth answering module will store the identification code (ID) of those electronic devices and give each electronic device a corresponding calling code with capability to obtain the corresponding ID so as to achieve the fast on-line change effect. Furthermore, U.S. Publication No. 2003/0055735 also discloses a method of using Bluetooth technology in wireless transmission.

Though mobile phone usage is widespread, it is still common that someone leaves his/her cubicle without carrying the mobile phone during the work. Consequently, when the mobile phone rings, nobody answers the phone and important incoming messages may be missed.

Therefore, there is a need to provide a method for managing an incoming call, so that fellow workers in the same group can take over to answer the other's incoming call as appropriate. Since wireless answering devices are widely used, there is a further need to provide a method for wirelessly managing an incoming call through wireless answering modules.

### SUMMARY OF THE INVENTION

In viewing the drawbacks of prior art, the present invention provides a system and a method for managing an incoming call.

One aspect of the present invention is to provide a system for managing an incoming call. When a mobile device receives an incoming call, other answering modules predefined as being in the same group with the mobile device can take over to answer the incoming call.

Another aspect of the present invention is to store an authentication matrix for grouping multiple answering modules into a same group in each answering module.

A further aspect of the present invention is to connect a mobile device to a corresponding answering module through the Bluetooth protocol.

In one embodiment of the present invention, a method for managing an incoming call is also provided. The method includes the steps of wirelessly connecting each mobile device to its corresponding answering module through Bluetooth protocol; storing an authentication matrix for grouping multiple answering modules into a same group in each answering module; and when a mobile device receives an incoming call, other answering modules within the same group can selectively take over to answer the incoming call.

According to still another aspect of the present invention, the answering module includes an activation device to activate or deactivate the take over answering function.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates answering modules within a group in accordance with one embodiment of the present invention;

FIG. 2 illustrates the grouping process in accordance with one embodiment of the present invention;

FIG. 3 illustrates an exemplary answering module in accordance with one embodiment of the present invention;

FIG. 4 illustrates a flow chart of managing an incoming call in accordance with one embodiment of the present invention;

FIG. 5 illustrates a flow chart of managing an incoming call in accordance with another embodiment of the present invention; and

FIG. 6 illustrates an exemplary grouping of answering modules in accordance with another embodiment of the present invention.

### DETAILED DESCRIPTION OF THE INVENTION

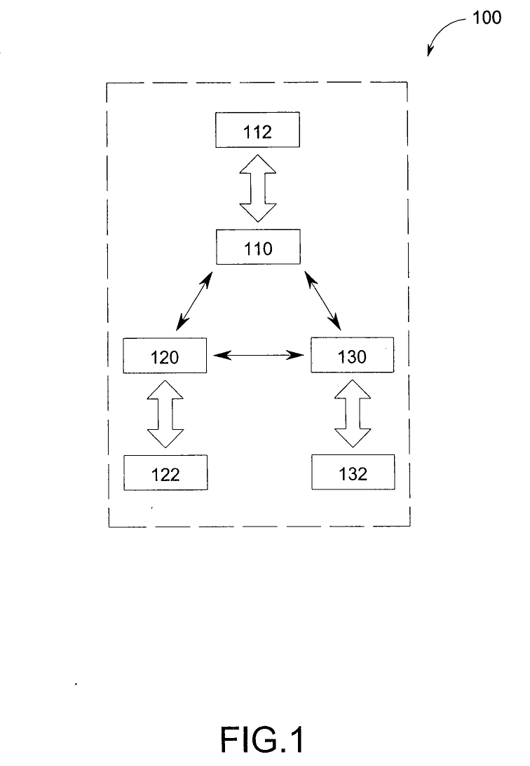

The present invention provides a system and a method for managing an incoming call. For better understanding, please refer to the following descriptions in conjunction with the accompanying FIGS. 1-6.

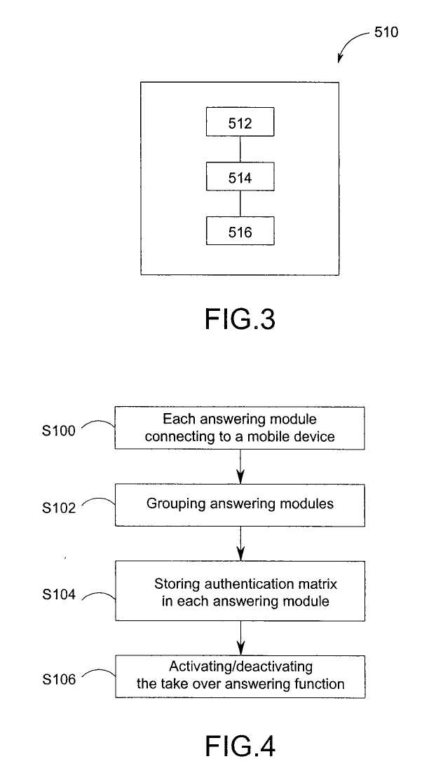

FIG. 1 illustrates answering modules within a group 100 in accordance with one embodiment of the present invention. The group 100 includes three answering modules 110, 120, and 130, which respectively correspond to mobile devices 112, 122, and 132. The mobile device can be a mobile phone, and the answering module can be a wireless Bluetooth earphone. An authentication matrix (shown in FIG. 3) configured to group answering modules into groups is stored in the answering modules 110, 120, and 130, respectively. By incorporating with the authentication matrix, the answering modules within the same group can take over to answer an incoming call for each other.

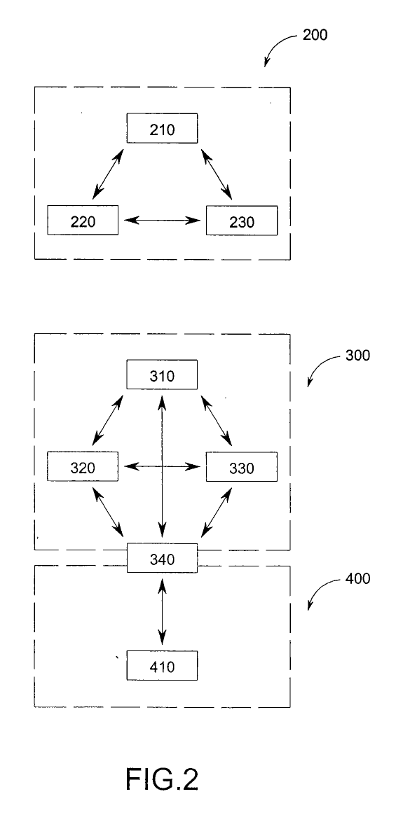

FIG. 2 illustrates an exemplary grouping process in accordance with another embodiment of the present invention. Groups 200, 300, and 400 respectively represent different groups classified to be capable of taking over to answer incoming calls for other members within the same group. Each group includes its corresponding answering modules. Each answering module matches a corresponding mobile device, which communicates with a telephone system, such as a GSM (Global System for Mobile communications) network. In an exemplary embodiment, the answering module is a Bluetooth transmitter/receiver, which is wirelessly connected to a mobile phone. Any two answering modules within the same group are configured to have the function of taking over to answer an incoming call for each other. For example, in the group 200, there are three exemplary relationships among the answering modules 210, 220, and 230, such as the answering modules 210 and 220 capable of taking over to answer an incoming call for each other; the answering modules 210 and 230 capable of taking over to answer an incoming call for each other; and the answering modules 220 and 230 capable of taking over to answer an incoming call for each other. In the group 300, there are six exemplary relationships among the answering modules 310, 320, 330, and 340. For example, the answering modules 310 and 320 are capable of taking over to answer an incoming call for each other. The answering modules 310 and 330 are capable of taking over to answer an incoming call for each other. The answering modules 310 and 340 are capable of taking over to answer an incoming call for each other. The answering modules 320 and 330 are capable of taking over to answer an incoming call for each other. The answering modules 320 and 340 are capable of taking over to answer an incoming call for each other, and the answering modules 330 and 340 are capable of taking over to answer an incoming call for each other. In other words, answering modules 310, 320, 330, and 340 in the group 300 are configured to have the function of taking over to answer incoming calls for other answering modules in the same group. Moreover, one answering module may belong to two different groups at the same time. For example, the answering module 340 is configured to be included in the groups 300 and 400. In the group 400, the answering modules 340 and 410 are capable of taking over to answer an incoming call for each other.

In the embodiment, the answering module wirelessly connects to its corresponding mobile device through the Bluetooth protocol. However, the present invention is applicable to other wireless communication protocols, such as Infrared transmission, and not limited to the embodiments.

The relationships among the answering modules of any group in FIG. 2 are defined in an authentication matrix. The authentication matrix is then stored in the corresponding answering modules.

As shown in FIG. 3, an answering module 510 includes an authentication matrix 512, an activation device 514, and an input device 516. The authentication matrix 512 is provided to configure the relationship among the answering module 510 and other answering modules within same group so that the answering modules in the very same group are capable of taking over to answer an incoming call based on the relationship defined in the authentication matrix 512. The authentication matrix 512 may be established by using the input device 516, such as a man-machine interface, to input identification codes for each module which is configured to take over to answer an incoming call, to define a waiting time T, to edit or to update the authentication matrix 512. The activation device 514 is configured to activate or deactivate the function of taking over to answer an incoming call for the answering module 510 by other answering modules in the same group. In addition, the activation or deactivation of the activation device 514 can be determined by using the input device 516. If the activation device 514 is deactivated, other answering modules within the group same as the answering module 510 cannot connect to the answering module 510, and accordingly cannot take over to answer an incoming call for the corresponding mobile phone of the answering module 510. Alternatively, if the activation device 514 is activated, the answering modules within the same group can take over to answer an incoming call for the answering module 510.

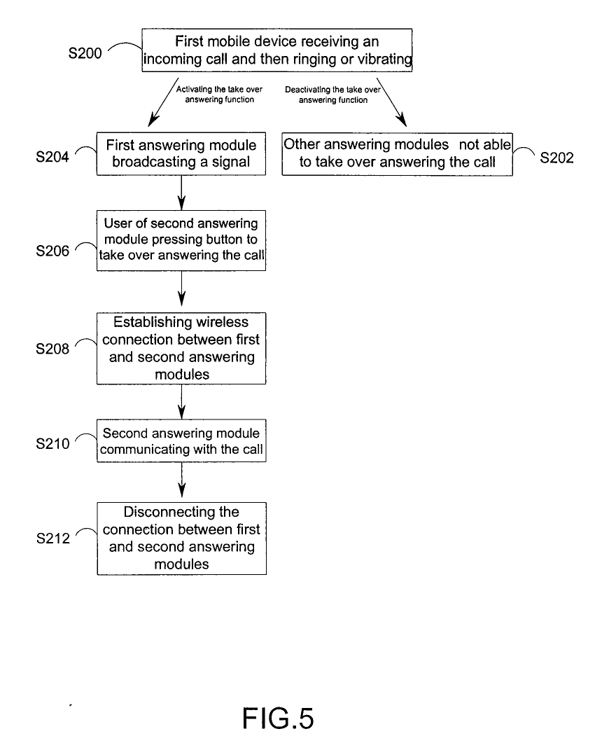

FIG. 4 illustrates a flow chart of managing an incoming call in accordance with one embodiment of the present invention. In step S100, each answering module wirelessly connects to a corresponding mobile device through Bluetooth or Infrared protocol. In step S102, answering modules are classified into groups, such as several groups or one group. For example, one answering module may be included in more than one group simultaneously. In step S104, an authentication matrix is established to configure relationships among the answering modules within the same group, and then stored in each corresponding answering module. In step S106, the function of taking over to answer an incoming call by other answering modules in the same group is selectively activated or deactivated.

Referring back to FIG. 1, the answering modules 110, 120, and 130 are configured in the same group 100, so that the three answering modules can take over to answer an incoming call for each other when the activation device in each answering module is activated.

When the mobile device 112 receives an incoming call from the telephone system, the mobile device 112 subsequently rings a original ring tone or vibrates to notice the user that an incoming call has been received. Within in a predetermined waiting time interval T, if the user of the mobile device 112 does not respond to the incoming call, or the call has not been answered by others directly, the answering module 110 of the mobile device 112 will then broadcast a ring message or ring a backup ring tone which is different from the original ring tone. The ring message may include an identification code for the answering module 110 or the group 100 so that other answering modules, such as 120 and 130, are able to determine whether the answering module 110 is within the same group. When the user of other answering modules in the same group, such as the answering module 120, recognizes the original ring tone, the backup ring tone or vibrations generated by the mobile device 112, the user of all answering modules may be noticed and some of them may selectively take over to answer the incoming call by pressing a button (not shown.) to have the answering module 120 search the ring message broadcasted in the group 100. When the answering module 120 locates the ring message being sent out by the answering module 110, the answering modules 120 and 110 proceed to an authentication process. Due to the relationship between the answering modules 110 and 120 is predefined in the authentication matrix, the answering module 120 is able to connect to the answering module 110 without inputting additional authentication code and to execute the communication subsequently. Accordingly, a radio link between the answering module 110 and the answering module 120 is established so that the answering module 120 establishes the communication with the incoming call through the answering module 110 and the audio signal is transferred to the answering module 120. When the communication between the answering module 120 and the incoming call is to be ended, the answering module 120 instructs the answering module 110 cut off the communication between the answering module 110 and the incoming call and return to a standby status. Furthermore, the answering module 110 can store information of the incoming call, such as data associated with the answering module 120, data associated with a caller, a communication starting time, a communication period or message signals, in the mobile device 112 so that the user of the mobile device 112 could make a query afterwards. The message signals may be voice messages or text messages from the callers or people who take over to answer the incoming call, so that the user of the mobile device 112 can realize that an incoming call has been answered or processed by others.

FIG. 5 illustrates a flow chart in accordance with another embodiment of the present invention, which illustrates the process of managing an incoming call. In step S200, a first mobile device receives an incoming call and then rings and/or vibrates to signal the coming of the call. If the take over answering function of the first mobile device is deactivated, the process proceeds to step S202, in which the incoming call cannot be taken over by other answering modules. If the take over answering function of the first mobile device is activated, the process proceeds to step S204, wherein a first answering module corresponding to the first mobile device broadcasts a ring message. In step 206, when the user of a second answering module detects the rings and/or vibrations, by pressing a button, the second answering module determines whether other answering modules in the same group is sending out the ring message. When the second answering module locates the ring message sent out by the first answering module, the process proceeds to step S208, in which a radio link between the first answering module and the second answering module is established. In step S208, an authentication procedure is performed by using the authentication matrix pre-stored in the first and the second answering modules. Then, the connection between the answering modules is automatically established. In step S210, the voice signal of the first answering module is transferred to the second answering module so as to communicate with the incoming call by the second answering module. Therefore, the second answering module communicates with the incoming call through the first answering module, the mobile device, and the telephone system. When the communication between the second answering module and the incoming call is to be ended, the procedure proceeds to step S212, wherein the connection between the first answering module and the second answering module is interrupted and the first answering module returns to a standby status. In step S212, the interruption of connection between the two answering modules is achieved by sending an interruption signal to the first answering module from the second answering module. Then, the first answering module sends an interruption confirmation signal back to the second answering module.

In these embodiments, the system of managing an incoming call is established by modifying configuration of the answering modules, such as configuring and storing the authentication matrix, and activating or deactivating the take over answering function. Therefore, the mobile device does not require additional modifications, and accordingly the cost is minimized. Though the present invention illustrates exemplary embodiments by modifying the configuration of answering modules, the present invention is not limited to embodiments; modifying the mobile device to achieve the effect of taking over to answer an incoming call by other answering modules in a same group is also included in the scope of the present invention.

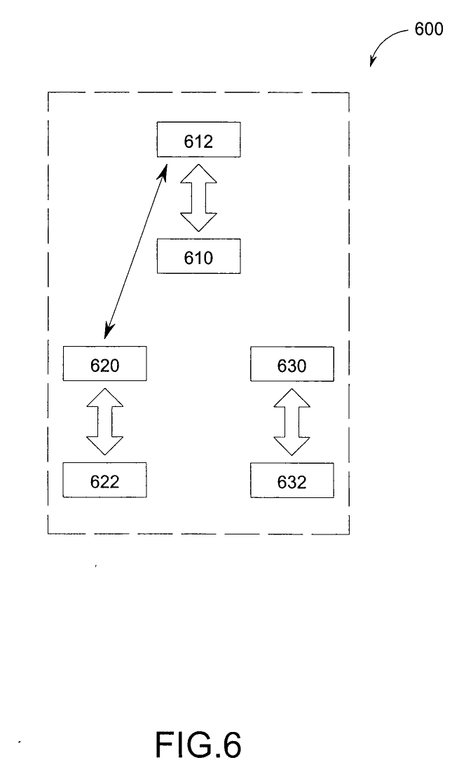

Referring to FIG. 6, in another embodiment of the present invention, a group 600 includes the answering modules 610, 620, and 630, which correspond to the mobile devices 612, 622, and 632 respectively. When the mobile device 612 receives an incoming call, and then rings or vibrates to signal the coming of the call, the answering module 620 does not need to connect to the answering module 610 to take over to answer the incoming call. Alternatively, the answering module 620 connects to the mobile device 612 to take over answering the incoming call. Therefore, the answering module 620 communicates with the incoming call through the mobile device 612, the telephone system.

Although specific embodiments have been illustrated and described, it will be obvious to those skilled in the art that various modifications may be made without departing from what is intended to be limited solely by the appended claims.

What is claimed is:

1. A system for managing an incoming call, comprising:
a first mobile device being wirelessly connected to a first answering module; and
a second mobile device being wirelessly connected to a second answering module, the first mobile device and the second mobile device communicating with a telephone system;
wherein an authentication matrix for grouping the first and the second answering modules into a same group is stored in both the first and the second answering modules, and when the first mobile device receives the incoming call through the telephone system, the second answering module selectively takes over to answer the incoming call.

2. The system of claim 1, wherein the second answering module answers the incoming call by activating the first answering module to answer the incoming call, so that the second answering module communicates with the incoming call through the first answering module, the first mobile device, and the telephone system.

3. The system of claim 1, wherein the second answering module answers the incoming call by wirelessly connecting to the first mobile device, so that the second answering module communicates with the incoming call through the first mobile device and the telephone system.

4. The system of claim 1, wherein the first mobile device and the first answering module are connected through Bluetooth protocol.

5. The system of claim 1, wherein the first answering module sends out a signal after a predetermined time period since the first mobile device receiving the incoming call, and the second answering module answers the incoming call when the second answering module receives the signal.

6. The system of claim 5, the signal further comprising at least one of a code for the first answering module, a code for the group, and a code for the authentication matrix.

7. The system of claim 1, wherein the first mobile device rings a first ring tone when the first mobile device receiving the incoming call and the first mobile device rings a second ring tone after a predetermined time period, the second ring tone is different to the first ring tone.

8. The system of claim 1, further comprising a third answering module being in a group same as the first answering module but different from the second answering module.

9. The system of claim 1, wherein the first answering module further comprises an activation device, when the activation device is deactivated, the second answering module is not allowed to take over answering the incoming call, and the second answering module is allowed to take over answering the incoming call when the activation device is activated.

10. The system of claim 1, wherein the first mobile device stores at least one of data associated with the second answering module, data associated with a caller, calling time of the incoming call, communication periods, and communication content between the second answering module and the incoming-call, wherein the communication content comprises a voice message or a text message.

11. A method for managing an incoming call, comprising the steps of:
wirelessly connecting a first mobile device to a first answering module;
wirelessly connecting a second mobile device to a second answering module, the first mobile device and the second mobile device communicating with a telephone system;
storing an authentic matrix for grouping the first and the second answering modules into a same group in both the first and the second answering modules; and
the second answering module selectively taking over to communicate with the incoming call when the first mobile device receives an incoming call through the telephone system.

12. The method of claim 11, further comprising:
activating the first answering module to answer the incoming call by the second answering module;
wherein the second answering module communicates with the incoming call through the first answering module, the first mobile device, and the telephone system.

13. The method of claim 11, further comprising:
connecting the second answering module to the first mobile device;
wherein the second answering module communicates with the incoming call through the first mobile device and the telephone system.

14. The method of claim 11, wherein the first mobile device and the first answering module are connected through Bluetooth protocol.

15. The method of claim 11, further comprising:
the first answering module sending out a signal after a predetermined time period since the first mobile device receives the incoming call; and
the second answering module establishing communication with the incoming call when the second answering module receives the signal.

16. The method of claim 15, wherein the signal comprises at least one of a code for the first answering module, a code for the group, and a code for the authentication matrix.

17. The method of claim 11, further comprising:
the first mobile device ringing a first ring tone when the first mobile device receiving the incoming call; and
the first mobile device ringing a second ring tone after a predetermined time period; wherein the second ring tone is different to the first ring tone.

18. The method of claim 11, further comprising:
storing at least one of data associated with the second answering module, data associated with a caller, calling time of the incoming-call, communication periods and communication content between the second answering module and the incoming call.

19. A method for managing an incoming call, comprising:
connecting a first mobile device to a first answering module;
connecting a second mobile device to a second answering module;
storing an authentic matrix for grouping the first and the second answering modules into a same group in the first and the second answering modules;
receiving the incoming call by the first mobile device;
ringing a first ring tone and ringing a second ring tone after a predetermined time period, the first ring tone and the second ring tone being different; and
one of the first answering module and the second answering module selectively answering the incoming call.
